(19) United States
(12) Patent Application Publication
(10) Pub. No.: US 2015/0010843 A1
(43) Pub. Date: Jan. 8, 2015

(54) MEMBRANE-ELECTRODE ASSEMBLY FOR FUEL CELL AND FUEL CELL STACK INCLUDING SAME

(71) Applicant: Samsung SDI Co., Ltd., Yongin-si (KR)

(72) Inventors: Kah-Young SONG, Yongin-si (KR); Sang-IL HAN, Yongin-si (KR); Hee-Tak KIM, Yongin-si (KR); Tae-Yoon KIM, Yongin-si (KR); Sung-Yong CHO, Yongin-si (KR); Myoung-Ki MIN, Yongin-si (KR); Geun-Seok CHAI, Yongin-si (KR)

(73) Assignee: Samsung SDI Co., Ltd., Yongin-si (KR)

(21) Appl. No.: 14/087,323

(22) Filed: Nov. 22, 2013

(30) Foreign Application Priority Data
Jul. 3, 2013 (KR) 10-2013-0078004

(51) Int. Cl. H01M 8/10; H01M 8/24

(52) U.S. Cl. CPC H01M 8/1004; H01M 8/2405; H01M 8/248
USPC 429/465; 429/480; 429/481

(57) ABSTRACT

A membrane-electrode assembly for a fuel cell that includes a polymer electrolyte membrane is disclosed. The membrane-electrode assembly for a fuel cell further includes an anode disposed on one side of the polymer electrolyte membrane and including an anode gas diffusion layer and a cathode disposed on the other side of the polymer electrolyte membrane and including a cathode gas diffusion layer. At least one of the anode gas diffusion layer and the cathode gas diffusion layer includes a water reservoir. The water reservoir includes a pore and a hydrophilic polymer inside the pore. A fuel cell stack including the membrane-electrode assembly is also disclosed.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. For example, this application claims priority to and the benefit of Korean Patent Application No. 10-2013-0078004 filed in the Korean Intellectual Property Office on Jul. 3, 2013, the entire contents of which are incorporated herein by reference.

### BACKGROUND

1. Field

The present disclosure relates to a membrane-electrode assembly for a fuel cell and a fuel cell stack including the same.

2. Description of the Related Technology

A fuel cell is a power generation system for converting chemical reaction energy of hydrogen contained in a hydrocarbon-based fuel with oxygen supplied separately, into electrical energy. Such a fuel cell may be a polymer electrolyte fuel cell or a direct oxidation fuel cell. The polymer electrolyte membrane fuel cell is composed of a stack forming a fuel cell body (hereinafter, referred to as stack) and generates electrical energy through oxidation of hydrogen supplied from a reformer and reduction of oxygen supplied through operation of an air-pump or fan. In the direct oxidation fuel cell, a fuel is directly supplied to a stack. Thus, unlike the polymer electrolyte membrane fuel cell, the direct oxidation fuel cell does not require a separate reformer. The direct oxidation fuel cell generates electrical energy from electrochemical oxidation of hydrogen, included in the fuel, and electrochemical reduction of oxygen, supplied separately.

In a fuel cell, the stack has a structure in which several to several tens of unit cells, composed of a membrane-electrode assembly (MEA) and separators (also referred to as bipolar plates), are stacked to one another. The MEA includes a polymer electrolyte membrane, a pair of electrode catalyst layers formed on both sides of the polymer electrolyte membrane, and a pair of gas diffusion layers outside of the electrode catalyst layers. Since a cathode in the MEA generates water through reduction reaction of oxygen during operation of a fuel cell, a flooding phenomenon of hindering diffusion of an oxidant gas occurs when the water is not smoothly discharged. In addition, the electrolyte layer and the cathode gas diffusion layer should maintain predetermined water-reserving property to improve generation efficiency of a fuel cell. Accordingly, research on maintaining a water-reserving property of the electrolyte layer and the cathode gas diffusion layer as well as prevent flooding.

### SUMMARY OF CERTAIN INVENTIVE ASPECTS

In one aspect, a membrane-electrode assembly for a fuel cell capable of easily discharging water generated during operation of a fuel cell and maintaining a predetermined water-reserving property is provided.

In another aspect, a fuel cell stack including a membrane-electrode assembly for a fuel cell is provided.

In another aspect, a membrane-electrode assembly for a fuel cell including a polymer electrolyte membrane is provided. The membrane-electrode assembly may further include, for example, an anode disposed on one side of the polymer electrolyte membrane and including an anode gas diffusion layer, and a cathode disposed on the other side of the polymer electrolyte membrane and including a cathode gas diffusion layer. In some embodiments, at least one of the anode gas diffusion layer and the cathode gas diffusion layer includes a water reservoir. In some embodiments, the water reservoir includes a pore and a hydrophilic polymer inside the pore.

In some embodiments, the pore may have a diameter of about 1 μm to about 2 mm. In some embodiments, the pore may have a depth of about 1 μm to about 500 μm from at least one surface of the anode gas diffusion layer and the cathode gas diffusion layer that are adjacent to the polymer electrolyte membrane. In some embodiments, the hydrophilic polymer may include a copolymer of vinyl alcohol and vinyl acetate, polyester, polyisopropyl acrylamide, polyethylene glycol (PEG), polypropylene glycol, polyacrylic acid, polyethylene oxide, polyvinyl acetate, polymethylmethacrylate, polyacetic acid, polyvinyl alcohol, or a combination thereof. In some embodiments, the hydrophilic polymer may be cross-linked. In some embodiments, the hydrophilic polymer may be cross-linked by a cross-linking agent, the cross-linking agent may include methyl acrylate, butyl acrylate, trimethylol propane triacrylate, butanediol dimethacrylate, diallyl suberate, ethylene glycol dimethacrylate, poly(ethylene glycol) dimethyl acrylate, diglycidyl ether, acryl amide, divinyl benzene, or a combination thereof. In some embodiments, the water reservoir may be positioned at an area including an air inlet contact with at least one gas diffusion layer of the anode gas diffusion layer and the cathode gas diffusion layer. In some embodiments, at least one of the anode gas diffusion layer and the cathode gas diffusion layer may include a microporous layer (MPL) positioned at a side of the polymer electrolyte membrane and a backing layer (BL) positioned at an outside of the microporous layer. In some embodiments, the water reservoir may be formed at the microporous layer, the backing layer, or combination thereof. In some embodiments, the anode may further include an anode catalyst layer, the anode catalyst layer may be adjacent to the polymer electrolyte membrane, and the anode gas diffusion layer may be positioned at outside of the anode catalyst layer. The cathode may further include a cathode catalyst layer, the cathode catalyst layer may be adjacent to the polymer electrolyte membrane, and the cathode gas diffusion layer may be positioned at outside of the cathode catalyst layer.

In another aspect, a fuel cell stack including electricity generating units is provided. In some embodiments, the electricity generating units include a membrane-electrode assembly (MEA) and separators disposed close to or contacting both sides of MEA and a pressing plate supporting the electricity generating units.

In another aspect, embodiments of the present disclosure may be capable of or configured to absorb moisture during operation of a fuel cell and suppress a flooding phenomenon, maintain an appropriate water-reserving property by discharging moisture stored during the operation of the fuel cell under a humid condition or at a high current density, and thus, improve generation efficiency of the fuel cell.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is an exploded perspective view showing a fuel cell stack according to one embodiment.

FIG. 2 is an exploded perspective view showing an electricity generating unit of a fuel cell stack according to one embodiment.

FIG. 3 is a side view showing a membrane-electrode assembly (MEA) for a fuel cell according to one embodiment.

FIG. 4 is a cross-sectional view showing a membrane-electrode assembly for a fuel cell taken along with the III-III line of FIG. 3.

FIG. 5 is a side view showing a membrane-electrode assembly (MEA) for a fuel cell according to another embodiment.

FIG. 6 is a cross-sectional view showing a membrane-electrode assembly for a fuel cell taken along with the X-X line of FIG. 5.

FIG. 7 is a front view showing a membrane-electrode assembly (MEA) for a fuel cell according to another embodiment.

### DETAILED DESCRIPTION OF CERTAIN INVENTIVE EMBODIMENTS

Hereinafter, with reference to accompanying drawings, disclosed embodiments are described so that a person having an ordinary skill in this art may implement the present invention. However, this disclosure may, however, be embodied in many different forms and is not construed as limited to the exemplary embodiments set forth herein.

As used herein, when specific definition is not otherwise provided, the term “combination” may refer to a mixture or copolymerization. The term “copolymerization” may refer to block copolymerization, random copolymerization, or graft copolymerization, and the term “copolymer” may refer to a block copolymer, a random copolymer, or a graft copolymer.

A membrane-electrode assembly (MEA) according to one embodiment includes a polymer electrolyte membrane, an anode disposed on one side of the polymer electrolyte membrane and including an anode gas diffusion layer and a cathode disposed on the other side of the polymer electrolyte membrane and including a cathode gas diffusion layer, wherein at least one of the anode gas diffusion layer and the cathode gas diffusion layer includes a water reservoir, and the water reservoir includes a pore and a hydrophilic polymer inside the pore.

A fuel cell stack according to another embodiment includes electricity generating units including the membrane-electrode assembly (MEA) and separators disposed on opposite sides of MEA and a pressing plate supporting the electricity generating units.

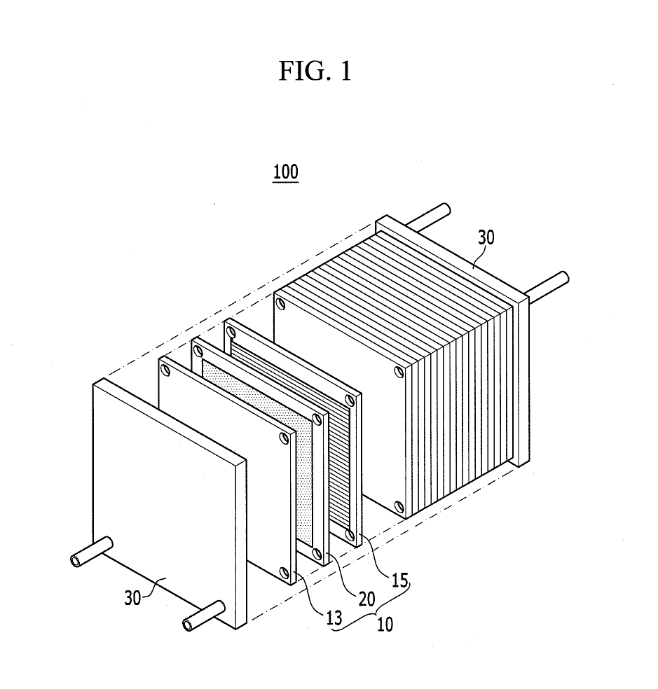

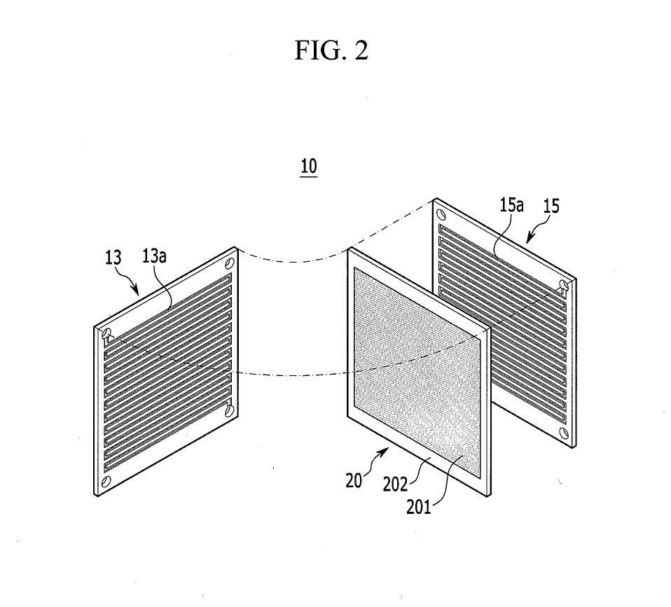

Referring to FIG. 1, a fuel cell stack according to one embodiment is described, and referring to FIG. 2, an electricity generating unit according to one embodiment is described. FIG. 1 is an exploded perspective view of a fuel cell stack according to one embodiment, and FIG. 2 is an exploded perspective view of an electricity generating unit of a fuel cell stack according to one embodiment. Referring to FIGS. 1 and 2, a fuel cell stack 100 includes an electricity generating unit 10 in a cell unit configured to generate or capable of generating electrical energy by electrochemically reacting a fuel with oxygen.

In one embodiment, a plurality of electricity generating units 10 are consecutively disposed and thus a fuel cell stack 100 is formed by an assembly structure of an electricity generating unit 10.

The fuel cell stack 100 uses hydrogen contained in a liquid or gas fuel such as methanol, ethanol, liquid petroleum gas (LPG), liquefied natural gas (LNG), gasoline, butane gas, or the like. The fuel cell stack 100 may adopt a direct oxidation fuel cell scheme where the electricity generating unit 10 is capable of generating or configured to generate electrical energy through direct reaction of liquid or gas fuel, and oxygen. Alternatively, the fuel cell stack 100 may use, as a fuel, hydrogen generated from cracking of liquid or gas fuel in a general reformer. In this case, the fuel cell stack 100 adopts a polymer electrolyte membrane fuel cell scheme where the electricity generating unit 10 generates electrical energy through reaction of hydrogen and oxygen. The fuel cell stack 100 according to one embodiment may use pure oxygen, stored in a separate storage unit or oxygen-containing air as oxygen that reacts with a fuel.

In the fuel cell stack 100, the electricity generating unit 10 includes a membrane-electrode assembly (MEA) 20 and separators (also referred to be ‘bipolar plates’) 13 and 15 disposed being close to the both sides of MEA to form a single stack, and the electricity generating unit 10 (a plurality of electricity generating units 10) to form a fuel cell stack 100 having a stack structure according to one embodiment.

A pressing plate 30 that makes a plurality of electricity generating unit 10 be close together may be disposed at the outermost of the fuel cell stack 100. However, the present disclosure is not limited thereto, the fuel cell stack 100 includes separators 13 and 15 positioned at the outermost of a plurality of electricity generating units 10 and playing a role of the pressing plate without the pressing plate 30. In addition, the pressing plate 30 may play an inherent role of the separators 13 and 15 as well as coupling or adhering together a plurality of the electricity generating units 10. The separators 13 and 15 are positioned closely adjacent to each other and respectively form a hydrogen passage path 13a and an air passage path 15a at both sides of the MEA 20. The hydrogen passage path 13a is positioned at the side of an anode 26 of the post-described membrane-electrode assembly 20, and the air passage path 15a is positioned at the side of a cathode 27 of the membrane-electrode assembly 20.

Herein, the hydrogen passage path 13a and air passage path 15a are respectively disposed as a straight line with a predetermined distance in the separators 13 and 15, and the both ends thereof are alternately connected and largely form a zigzag shape. However, the disposition structure of the hydrogen passage path 13a and the air passage path 15a is not limited thereto.

This membrane-electrode assembly 20 positioned at both sides of the separators 13 and 15 has a predetermined area and an active area 201 where an oxidation/reduction reaction occurs and also, an inactive area 202 connected to the edge of the active area 201. Herein, the inactive area 202 is equipped with a gasket (not shown) sealing an edge where the separators 13 and 15 correspond to the active area 201.

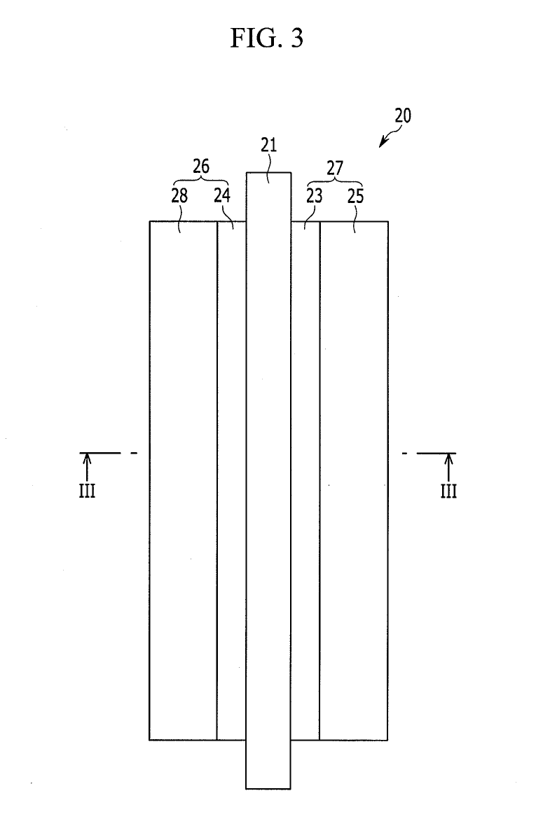

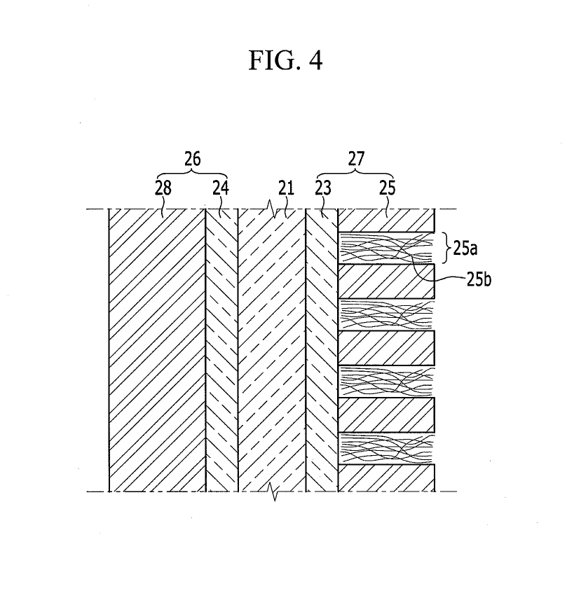

FIG. 3 is a side view of a membrane-electrode assembly (MEA) for a fuel cell according to one embodiment, and FIG. 4 is a cross-sectional view of a membrane-electrode assembly for a fuel cell taken along with the III-III line of FIG. 3. Referring to FIGS. 3 and 4, the membrane-electrode assembly 20 has an anode 26 and a cathode 27 on both sides of the active area 201 and a polymer electrolyte membrane 21 between the two electrodes 26 and 27. The polymer electrolyte membrane 21 is formed of a solid polymer electrolyte having a thickness ranging from about 5 μm to about 200 μm and plays a role of ion-exchanging for transferring protons generated from an anode catalyst layer 24 to a cathode catalyst layer 23. This ion exchange may be most efficiently performed when the polymer electrolyte membrane 21 is configured to have or is capable of having a water-reserving property. Thus, in some embodiments, the polymer electrolyte membrane 21 is formed with features capable of retaining water.

The anode 26 on one side of the membrane-electrode assembly 20 is supplied with hydrogen gas through a hydrogen passage path 13a between the separator 13 and the membrane-electrode assembly 20 and includes an anode gas diffusion layer (GDL) 28 and an anode catalyst layer 24. The anode gas diffusion layer 28 includes a carbon paper, a carbon cloth, or a combination thereof, and a plurality of holes (not shown) are formed. In addition, the anode gas diffusion layer 28 supplies hydrogen gas received through the hydrogen passage path 13a to the anode catalyst layer 24 through the holes. The anode catalyst layer 24 oxidizes the hydrogen gas into electrons and then, transports the electrons to a cathode 27 through the separator 15 neighboring with the cathode 27 and protons through a polymer electrolyte membrane 21 to the cathode 27. Herein, the electricity generating unit 10 generates electrical energy as the electron flow. The anode gas diffusion layer 28 may have a thickness ranging from about 100 μm to about 500 μm but is not limited thereto. In some embodiments, the anode gas diffusion layer 28 may have a thickness of about 100, 150, 200, 250, 300, 350, 400, 450, or 500 μm or any range therebetween.

In addition, the cathode to which protons generated from the anode 26 through the polymer electrolyte membrane 21 are transferred, receives the air containing oxygen through the air passage path 15a between the separator 15 and the MEA 20 and includes a cathode gas diffusion layer 25 and a cathode catalyst layer 23. The cathode gas diffusion layer 25 is formed of a carbon paper, a carbon cloth, or a combination thereof, and a plurality of holes (not shown) are formed in the cathode gas diffusion layer 25. The cathode gas diffusion layer 25 supplies the cathode catalyst layer 23 with the air passed through the air passage path 15a. The cathode catalyst layer 23 produces heat at a predetermined temperature and water by reducing oxygen in the air, and the protons and electrons transported from the anode 26. The cathode gas diffusion layer 25 may be about 100 μm to about 500 μm thick, but is not limited thereto.

Referring to FIG. 4, the cathode gas diffusion layer 25 includes a pore 25a and a water reservoir including a hydrophilic polymer 25b in the pore 25a. FIG. 4 shows one example of the cathode gas diffusion layer 25 having the water reservoir but is not limited thereto. In other words, the water reservoir may be included in the anode gas diffusion layer or in both of the cathode gas diffusion layer and the anode gas diffusion layer.

The water reservoir may absorb or store moisture under a humid condition or at a high current density during operation of a fuel cell and suppress a flooding phenomenon, and discharges the stored moisture and maintains appropriate water-reserving property under a non-humid condition or at a low current density and thus, may improve generation efficiency of the fuel cell.

In general, the higher a current density is during operation of a fuel cell, the more moisture is generated.

The pore 25a may have a diameter ranging from about 1 μm to about 2 mm. In some embodiments, the pore 25a has a diameter of about 1, 2, 3, 4, 5, 6, 7, 8, 9, 10, 20, 30, 40, 50, 60, 70, 80, 90, 100, 200, 300, 400, 500, 600, 700, 800, 900, 1000, 1100, 1200, 1300, 1400, 1500, 1600, 1700, 1800, 19, 2000 μm or any range or number therebetween. When the pore 25a has a diameter within range, gas diffusion is not hindered. Specifically the pore 25a may have a diameter ranging from about 1 μm to about 2 mm and more specifically, about 1 μm to about 50 μm. In some embodiments, the pore 25a has a diameter of about 1, 2, 3, 4, 5, 6, 7, 8, 9, 10, 15, 20, 25, 30, 35, 40, 45, 50 μm or any range or number therebetween.

The pore 25a may be about 1 μm to about 500 μm deep from the surface of the cathode gas diffusion layer 25. In some embodiments, the pore 25a has a depth of about 1, 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500 μm or any range or number therebetween. When the pore 25a has a depth within the range, the pore separates a passage for water and thus, smoothly may move the water from the water reservoir to the cathode catalyst layer and more effectively supply a fuel in the cathode gas diffusion layer. Specifically, the pore 25a may be about 1 μm to about 500 μm deep from the surface of the cathode gas diffusion layer 25 and more specifically, about 1 μm to about 20 μm deep.

For example, the pore 25a may be formed by irradiating an ion beam, an electron beam, a neutron beam, a γ-ray, or a combination thereof on the surface of the cathode gas diffusion layer 25, but is not limited thereto. In addition, the water reservoir, for example, may be formed by coating the hydrophilic polymer 25b or a mixture of the hydrophilic polymer 25b and a cross-linking agent on the surface of the cathode gas diffusion layer 25, thereby filling the hydrophilic polymer 25b to the pore 25a, but is not limited thereto. The coating procedure may include screen printing, dipping, impregnation, permeation, or a combination thereof.

In addition, the hydrophilic polymer 25b may be cross-linked by irradiating a heat, a γ-ray, an ultraviolet (UV) ray, and the like on the water reservoir including the hydrophilic polymer 25b but is not limited thereto. When the hydrophilic polymer 25b itself includes a cross-linking functional group, the hydrophilic polymer 25b may be cross-linked without using an additional cross-linking agent. However, the present disclosure is not limited thereto, and the cross-linking may be omitted.

When the hydrophilic polymer is dissolved in water to remove or washed away by water, the cross-linking process may fix the hydrophilic polymer into the pore. Specifically, the hydrophilic polymer may include a copolymer of vinylalcohol and vinylacetate, polyester, polyisopropyl acrylamide, polyethylene glycol (PEG), polypropylene glycol, polyacrylic acid, polyethyleneoxide, polyvinylacetate, polymethylmethacrylate, polyacetic acid, polyvinyl alcohol, or a combination thereof, but are not limited thereto. Specifically, the cross-linking agent may use acrylate, butyl acrylate, trimethylolpropane triacrylate, butanediol dimethacrylate, diallyl suberate, ethylene glycol dimethacrylate, poly(ethylene glycol) dimethyl acrylate, diglycidyl ether, acrylamid, divinylbenzene, or a combination thereof, but is not limited thereto.

A plurality of the water reservoirs may be formed apart one another in the cathode gas diffusion layer and also, an area including fuel and air inlets, but it is not limited thereto. When the water reservoir is formed in the area including fuel and air inlets, performance decrease or deterioration of a membrane-electrode assembly due to dryness may be prevented when a dry gas flows in, and the membrane-electrode assembly may be effectively operated by removing water when oversaturated gas flows in. In addition, the water reservoir may be mainly formed in a drier area during operation of a fuel cell, but is not limited thereto.

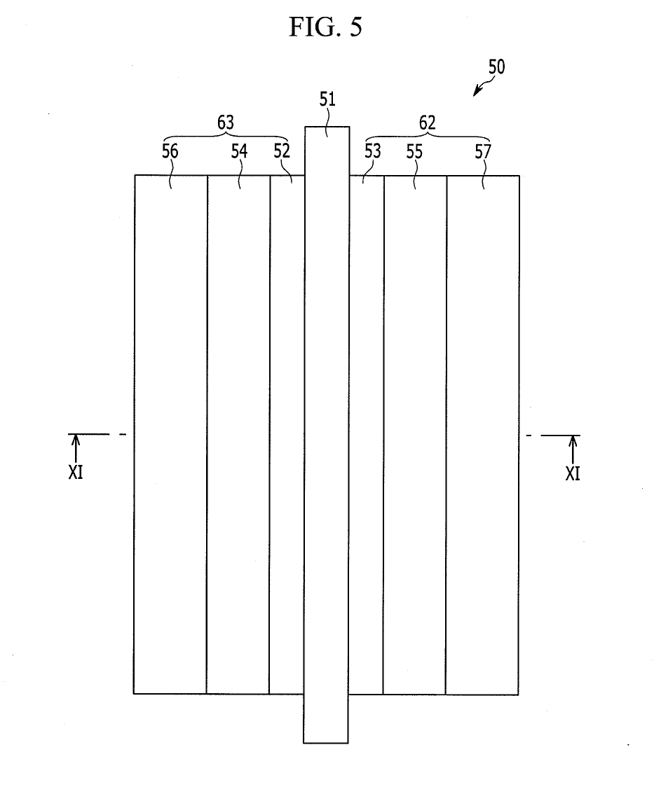

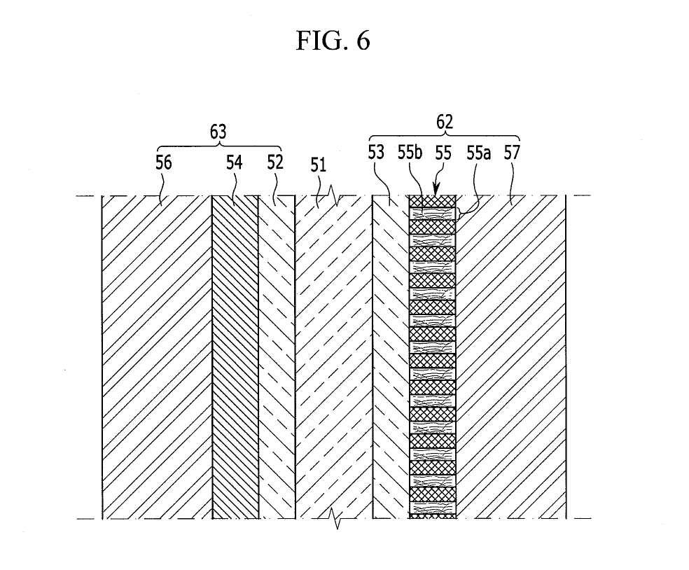

FIG. 5 is a side view of a membrane-electrode assembly (MEA) for a fuel cell according to another embodiment, and FIG. 6 is a cross-sectional view of a membrane-electrode assembly for a fuel cell taken along with the X -X line of FIG. 5. Referring to FIGS. 5 and 6, a membrane-electrode assembly 50 according to another embodiment includes an anode 63, a cathode 62, and a polymer electrolyte membrane 51 between these two electrodes 62 and 63. The membrane-electrode assembly 50 has the same structure as that of a membrane-electrode assembly shown in FIGS. 3 and 4, and thus, the redundant explanation of the same structure is omitted except for forming microporous layers (MPL) 54 and 55 in a gas diffusion layer and backing layers (BL) 56 and 57.

The anode 63 of the membrane-electrode assembly 50 includes a anode catalyst layer 52 contacting with one side of the polymer electrolyte membrane 51, an anode microporous layer (MPL) 54 outside of the anode catalyst layer 52, and an anode backing layer 56. The anode microporous layer 54 is positioned between the anode catalyst layer 52 and the anode backing layer 56, and the anode microporous layer 54 and the anode backing layer 56 forms an anode gas diffusion layer.

The cathode 62 includes a cathode catalyst layer 53 contacting with the polymer electrolyte membrane 51, a cathode microporous layer (MPL) formed outside of the cathode catalyst layer 53, and a cathode backing layer 57. The cathode microporous layer 55 is positioned between the cathode catalyst layer 53 and the cathode backing layer 57, and the cathode microporous layer 55 and the cathode backing layer 57 forms a cathode gas diffusion layer.

The anode backing layer 56 and cathode backing layer 57 may be formed of a carbon paper, a carbon cloth, or a combination thereof, and holes (not shown) are formed therein.

The anode microporous layer 54 and the cathode microporous layer 55 may be formed of graphite, carbon nanotube (CNT), fullerene (C₆₀), activated carbon, carbon nano horn, or the like and include a plurality of smaller holes (not shown) than holes formed in the backing layers 56 and 57. These microporous layers 54 and 55 play a role of further dispersing gas and transporting the gas to catalyst layers 52 and 53.

The cathode backing layer 57 transports the air passed through an air passage path to the cathode microporous layer 55 through the holes, and the cathode microporous layer 55 further disperses the transported air to the cathode catalyst layer 53. The cathode catalyst layer 53 reduces oxygen in the air and protons and electrons with oxygen moved from the anode 63 and produce a heat at a predetermined temperature and water.

The anode microporous layer 54 may be less than or equal to about 100 μm thick, the anode backing layer 56 may be about 50 μm to about 500 μm thick, the cathode microporous layer 55 may be less than or equal to about 100 μm, and the cathode backing layer 57 may be about 50 μm to about 500 μm thick, but is not limited thereto. In some embodiments, the anode microporous layer 54 may be about 10, 20, 30, 40, 50, 60, 70, 80, 90 or 100 μm thick or any range therebetween. In some embodiments, the cathode backing layer 57 may be about 50, 100, 150, 200, 250, 300, 350, 400, 450 or 500 μm thick or any number or range therebetween.

Referring to FIG. 6, the cathode microporous layer 55 includes a water reservoir a pore 55a and a hydrophilic polymer 55b in the pore 55a. However, the present disclosure is not limited thereto, and the water reservoir is formed in the cathode backing layer 57 or the cathode microporous layer 55 and the cathode backing layer 57. The position, diameter, and depth of the water reservoir may be adjusted by appropriately controlling a process of forming a pore and coating a hydrophilic polymer.

Unless a specific explanation is provided, a water reservoir, function of the water reservoir, a pore, a hydrophilic polymer, and a method of forming the water reservoir are the same as the aforementioned. For example, the pore 55a may be about 1 μm 500 μm deep from the surface of the cathode microporous layer 55. When the pore 55a has a depth within the range, diffusion resistance may be decreased due to fast movement and absorption of water and separation of passages for water and gas. Specifically, the pore 55a may be about 1 μm to about 500 μm deep from the surface of the cathode microporous layer 55 and more specifically, about 1 μm to about 20 μm.

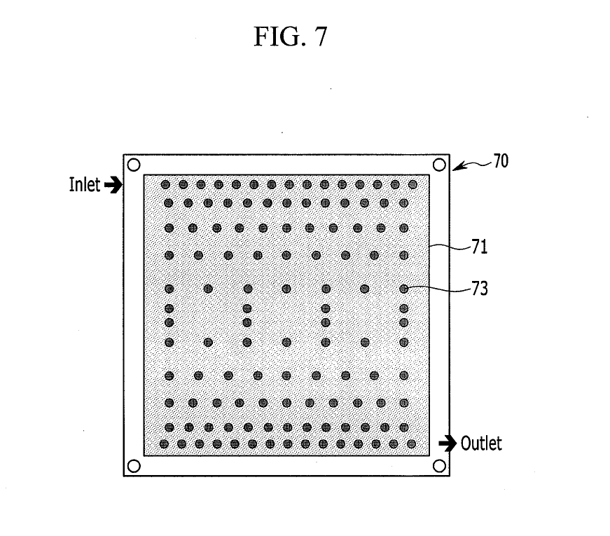

FIG. 7 is a front view of a membrane-electrode assembly (MEA) for a fuel cell according to another embodiment. Referring to FIG. 7, a membrane-electrode assembly 70 according to one embodiment includes a plurality of water reservoirs 73 positioned apart one another in a cathode gas diffusion layer 71. However, a water reservoir may not have a shape provided in FIG. 7, but various shapes would be acceptable. For example, acceptable shapes include spherical, conical, polygonal, or cube-shaped.

Unless a different explanation is provided, a membrane-electrode assembly, a cathode gas diffusion layer, and a water reservoir may be the same as aforementioned.

According to one embodiment, a membrane-electrode assembly and a fuel cell stack includes a water reservoir including a hydrophilic polymer in a cathode gas diffusion layer and thus, absorbs moisture during operation of a fuel cell under a humid condition or at a high current density and suppresses a flooding phenomenon and discharges the stored moisture during operation of the fuel cell under non-humid condition or at a low current density and maintains appropriate water-reserving property and thus, may improve generation efficiency of the fuel cell.

Hereinafter, examples and comparative examples provide further detail. However, it is understood that the present disclosure is not limited by these examples.

### Example 1

A 50 μm-deep hole having a diameter of 50 μm was formed every 5 mm apart on a carbon paper by using a Nd-YAG laser. The carbon paper was used by coating 5 wt % of polytetrafluoroethylene (PTFE) on a carbon paper. The gas diffusion layer having holes was impregnated in a solution prepared by dissolving 2 wt % of a copolymer of vinyl alcohol and vinyl acetate (vinyl alcohol monomer: vinyl acetate mononer=3:1 weight ratio) in water at room temperature. In general, a gas diffusion layer is treated with a water repellent on the surface of and thus, has no affinity for water, but the gas diffusion layer perforated with a laser became hydrophilic around the holes and had affinity for water. Accordingly, the solution was selectively permeated around the holes. Subsequently, the treated gas diffusion layer was taken out of the solution and dried. The gas diffusion layer including a water reservoir was formed by irradiating with γ-rays for cross-linking, since the impregnated material might be melt out during the operation of a membrane-electrode assembly.

### Example 2

A 50 μm-deep hole having a diameter of 50 μm was formed every 5 mm apart on a carbon paper by using a Nd-YAG laser. The carbon paper was used by coating 5 wt % of polytetrafluoroethylene (PTFE) on a carbon paper. The gas diffusion layer having the holes was impregnated in a mixed solution prepared by dissolving 2 wt % of polyvinyl alcohol in 95° C. water. In general, a gas diffusion layer is treated with a water repellent and has no affinity for water surface, but the gas diffusion layer perforated with a laser became hydrophilic around the holes and had affinity for water. Accordingly, the solution was selectively permeated around the holes. The treated gas diffusion layer was taken out of the solution and dried, forming a gas diffusion layer including a water reservoir.

### Comparative Example 1

A gas diffusion layer formed by coating 5 wt % of polytetrafluoroethylene (PTFE) on a carbon paper and casting carbon slurry to form a microporous layer was used.

### Evaluation 1: Measurement of Water Uptake Amount

The initial weight of the cathode gas diffusion layers according to Examples 1 and 2 and Comparative Example 1 was measured, and then, the weight of the cathode gas diffusion layers after moisture was absorbed under a humid condition. As a result, the gas diffusion layers having a water reservoir according to Examples 1 and 2 absorbed moisture, and their weight increased about 10%, while the gas diffusion layer having no water reservoir according to Comparative Example 1 did not absorb moisture, and its weight increased about 2%.

While this disclosure has been described in connection with what are presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A membrane-electrode assembly for a fuel cell, comprising
a polymer electrolyte membrane;
an anode disposed on a first side of the polymer electrolyte membrane, the anode including an anode gas diffusion layer; and
a cathode disposed on a second side of the polymer electrolyte membrane, the cathode including a cathode gas diffusion layer,
wherein at least one of the anode gas diffusion layer and the cathode gas diffusion layer includes a water reservoir,
wherein the water reservoir includes a pore and
wherein a hydrophilic polymer is positioned inside the pore.

2. The membrane-electrode assembly of claim 1, wherein the pore has a diameter of about 1 μm to about 2 mm.

3. The membrane-electrode assembly of claim 1, wherein the pore has a depth of about 1 μm to about 500 μm from at least one surface of the anode gas diffusion layer and the cathode gas diffusion layer adjacent to the polymer electrolyte membrane.

4. The membrane-electrode assembly of claim 1, wherein the hydrophilic polymer is formed from a copolymer of vinyl alcohol and vinyl acetate, polyester, polyisopropyl acrylamide, polyethylene glycol (PEG), polypropylene glycol, polyacrylic acid, polyethylene oxide, polyvinyl acetate, polymethylmethacrylate, polyacetic acid, polyvinyl alcohol, or a combination thereof.

5. The membrane-electrode assembly of claim 1, wherein the hydrophilic polymer is cross-linked.

6. The membrane-electrode assembly of claim 1, wherein the hydrophilic polymer is cross-linked by a cross-linking agent, and wherein the cross-linking agent is formed from methyl acrylate, butyl acrylate, trimethylol propane triacrylate, butanediol dimethacrylate, diallyl suberate, ethylene glycol dimethacrylate, poly(ethylene glycol) dimethyl acrylate, diglycidyl ether, acryl amide, divinyl benzene, or a combination thereof

7. The membrane-electrode assembly of claim 1, wherein the water reservoir is positioned at an area including an air inlet contact with at least one gas diffusion layer of the anode gas diffusion layer and the cathode gas diffusion layer.

8. The membrane-electrode assembly of claim 1, wherein at least one of the anode gas diffusion layer and the cathode gas diffusion layer comprises a microporous layer (MPL) positioned at a side of the polymer electrolyte membrane, and wherein a backing layer (BL) is positioned outside of the MPL

9. The membrane-electrode assembly of claim 8, wherein the water reservoir is formed at the microporous layer, the backing layer, or a combination thereof

10. The membrane-electrode assembly of claim 1, wherein the anode further comprises an anode catalyst layer, wherein the anode catalyst layer is adjacent to the polymer electrolyte membrane, wherein the anode gas diffusion layer is positioned outside of the anode catalyst layer, wherein the cathode further comprises a cathode catalyst layer, wherein the cathode catalyst layer is adjacent to the polymer electrolyte membrane, and wherein the cathode gas diffusion layer is positioned outside of the cathode catalyst layer.

11. A fuel cell stack including electricity generating units comprising:
the membrane-electrode assembly (MEA) of claim 1 and separators disposed on opposing sides of MEA, and
a pressing plate supporting the electricity generating units.
